(19) United States
(12) Patent Application Publication
(10) Pub. No.: US 2008/0045283 A1
(43) Pub. Date: Feb. 21, 2008

(54) Transfer of Game Characters

(75) Inventors: Timothy Stamper, Twycross (GB); Christopher Stamper, Twycross (GB); Paul Machacek, Twycross (GB)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/465,085

(22) Filed: Aug. 16, 2006

(51) Int. Cl. A63F 13/00

(52) U.S. Cl. 463/1

(57) ABSTRACT

A method of translating data relating to a character in a game is described. The method produces amended data relating to the character which may be imported into another game or other application. The method involves identifying the target application and an attribute of the exported character data and then modifying the character data based on this information.

### BACKGROUND

Current game characters exist only within a particular game and cannot be transferred to other games, with the exception of game derivatives which may permit aspects of a game character to be transferred (e.g. a first football game may relate to college football, whilst a derivative of this game, produced by the same company, may relate to the professional football league). Whilst game derivates can be written to ensure that the character data in the related games is compatible and therefore transfer of characters is possible, this is not the case for games which are not closely related and/or produced by different companies.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A method of translating data relating to a character in a game is described. The method produces amended data relating to the character which may be imported into another game or other application. The method involves identifying the target application and an attribute of the exported character data and then modifying the character data based on this information.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram showing the aspects of a game character;

FIG. 2 is an example flow diagram of a method of transferring a character between games;

FIGS. 3-8 are example flow diagrams of methods of translating one or more aspects of a character; and

FIG. 9 is a schematic diagram of an apparatus for performing the described methods.

### Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

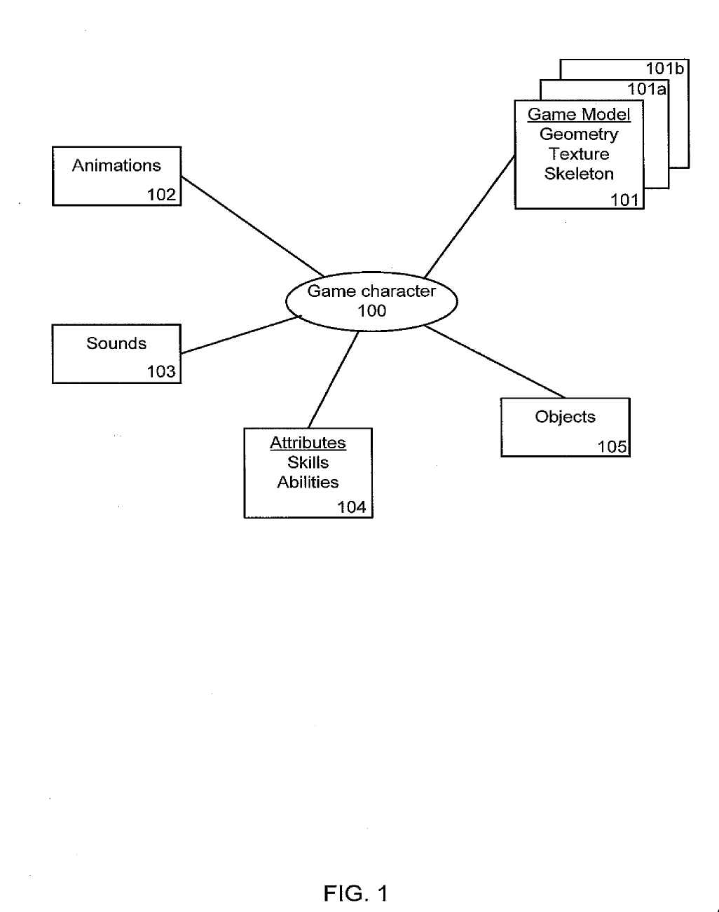

There are many aspects to a character in a game, as shown in the schematic diagram of FIG. 1 and a game character 100 may traditionally comprise a model 101 (referred to as a character or game model) which contains geometry information, textures, skeletons for animation and basic (non-drawn) geometric shapes that encompass the model's geometry. The character may also have associated animations 102 (e.g. moves that the character can perform), sounds 103 (e.g. sound effects, speech etc), skill/ability attributes 104, object attributes 105 (e.g. items that the character is carrying) etc which may be unique to that character or shared with other characters.

The term ‘character’ is used herein to refer to both living creatures (e.g. animals, humans, alien life forms etc) and objects, such as machines (e.g. vehicles and other craft etc) and buildings.

The character model may come in several levels of detail (LODs), either all within the same data structure and separated by switches, or as several individual data structures 101, 101a, 101b. The use of several LODs assists where character models are transferred between gaming devices (e.g. as described in co-pending U.S. patent application Ser. No. 11/425,258, entitled ‘Transfer of Features Between Gaming Devices’, filed on 20 Jun. 2006, which is incorporated herein by reference) because the cheaper/smaller lower LOD can be transferred first for quick access before the larger higher LOD is transferred. For example, a vehicle may be modeled three times, one in high detail for close up viewing, one in medium detail and one in low detail for viewing at a distance. The lower detail model will have fewer polygons, textures and general detail than the high quality model with the medium quality being somewhere between the two. The low quality model therefore is a smaller block of data which is much easier to transfer over a network to other gaming devices. A lower LOD model may, in some examples, have a simpler set of animations associated with it, compared to a higher LOD model.

The format in which the character data (including the character model) is stored varies from game to game even though there are only a small number of tools which are used to produce the models. This is because there are many extra details which can be added to adjust a character's physical characteristics, motion, LODs etc. Additionally, formats may be altered to improve storage or processing efficiency. As a result character data and character models are generally stored in a custom format for each particular game (or group of related games, as described above).

The skill/ability attributes associated with a character may be preset by the developer or may have been altered during the course of the game play as upgrades or as a response to certain tasks being achieved. For instance the character may have been in the gym, or been fighting a lot, and may therefore have built up a greater degree of strength. This may be defined by one or more parameters that detail the strength, any specific areas of the character's body it applies to and other factors like the strength's endurance. The strength may, in some examples, be incorporated in the way that the character is depicted so that a stronger character has the geometry of its model altered to make the character's arms or legs larger and more muscular in appearance.

The object attributes associated with a character may relate to items that the character owns or is carrying. These objects may be treated as an extension of the asset set that comprise the character, or could be treated as separate characters in their own right, as it may be possible that once a character has transferred to another game world and brought one or more objects with them, they might then lose or leave these objects in the receiving (or target) game world. If these object attributes can be separated from the character with which they are associated, they may need to bring their own models, animations, textures, skeletons, attributes, features, sounds etc.

Although most characters are defined by a game developer, some games enable the creation of custom characters from a library of parts (e.g. different body, head, limb types or different vehicle chassis, wheels, engines etc). Such games often include an object engine which is capable of determining how the newly created character moves based on the exact combination of parts used and the way in which they are connected together (e.g. an animal with one leg will hop, an animal with two legs will be bipedal etc).

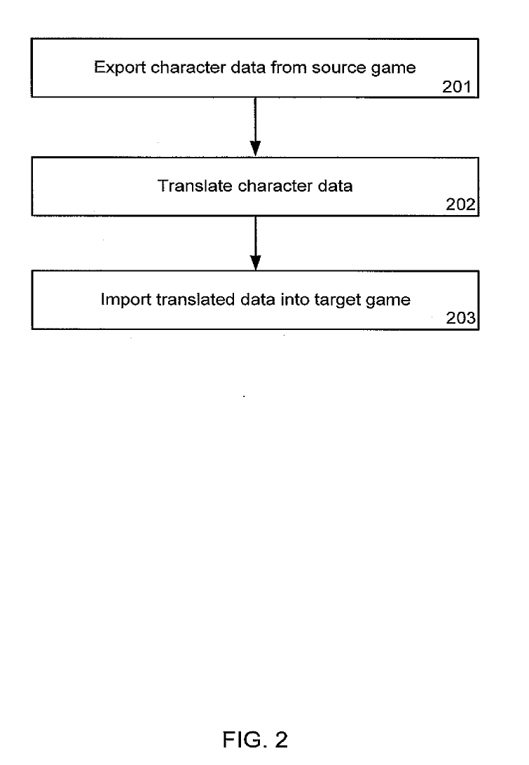

In order to transfer a character between games, some or all of these aspects may be exported (step 201) from the source game (i.e. the game in which the character initially exists) and imported into the target game (step 203), as shown in the example flow diagram in FIG. 2. In order to enable the importation of the character into the target game (in step 203), it may be necessary to translate aspects of the character (step 202), so that the character fits into the new game world (e.g. in physical size, strength/abilities and compatibility of associated objects). A number of different translation methods are described below. Each method may be used independently or in combination with aspects of one or more of the other methods.

The data exported from the source game (in step 201) may include data on all aspects of the character (e.g. as shown in FIG. 1) and the format of this exported data may be defined within the source game. Where the character is defined by the gamer (as described above) the exported data may include data on how the newly created character moves and this may be in the form of a plug-in for the target game. Further detail on the content and format of the exported character data is provided in the description of the translation methods below.

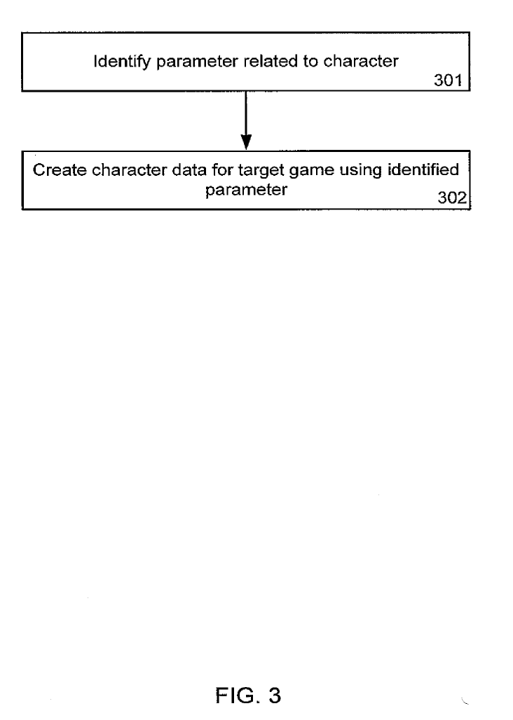

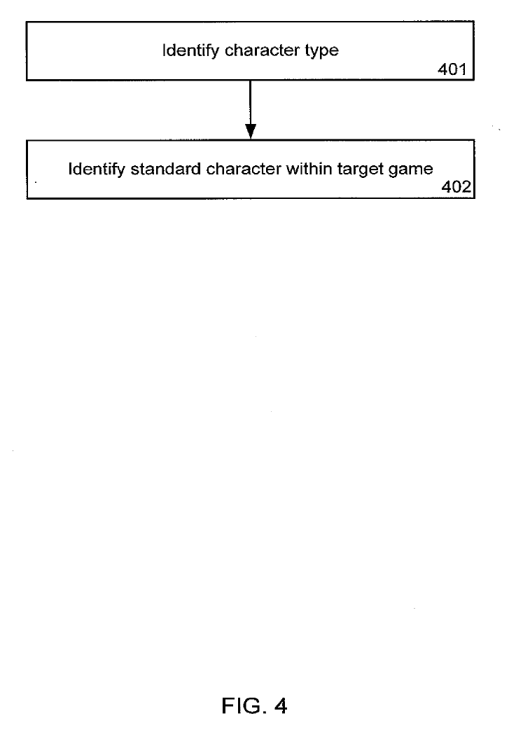

FIG. 3 shows an example method of translating one or more aspects of a character which has been exported from the source game and which is to be imported into the target game. A parameter relating to the character to be imported into the target game is identified (step 301) from the exported character data and then character data for importation into the target game is created using this identified parameter (step 302). This character data for importation into the target game is also referred to as ‘amended character data’ and dependent upon the circumstances and the translation method used, the amended character data may be the same as the exported character data, may comprise a sub-set of the exported character data or may differ from the exported character data. More detailed examples of the method if FIG. 3 are described below and shown in FIGS. 4-8. Although these flow diagrams show five different examples, aspects of any of the methods described may be combined with one or more aspects from any of the other methods described to create alternative methods of translating one or more aspects of a character.

FIG. 4 shows an example method of translating one or more aspects of a character which selects one of a set of default characters within the target game. The character type is identified from the exported character data (step 401). This character type may, for example, indicate that the character is a humanoid character, a vehicle, a building (e.g. a single storey building) etc. The type may be identified from a data packet within the exported character data, as described below, and depending on the granularity used, the type may be general (e.g. weapon) or more specific (e.g. sword). Based on this identified type, and in some examples on additional information from the exported character data, one of a set of default characters within the target game is identified (step 402) and this default character is used instead of the actual character when the character is imported into the target game. The exported character data may be modified such that it is replaced by character data for the selected default character or such that it comprises a reference to the selected default character. In an example, the exported character may be of type ‘humanoid’ and therefore the default character selected from the set of default characters for the target game (in step 402) will be the default character of type ‘humanoid’.

In addition to, or instead of using this method to translate the character, aspects of the character such as objects carried or owned by the exported character may be translated using this method to one of a default set of objects within the target game. Furthermore, the method may be used to translate objects which are independent of or separable from a character exported from the source game; such objects are contained within the definition of a character (see above). In such an example an object may be of type ‘weapon’ and sub-type ‘sword’ (this object type is identified in step 401). As described above, the object may be carried/owned by the exported character or the object may be exported as an independent character. In this example, the default object selected will be a default object of type ‘weapon’ and sub-type ‘sword’, if one is available, and if not the closest default object may be selected (e.g. a default object of type ‘weapon’). As described above, the character data may be amended to comprise data relating to the selected default object and this data may be a reference to the selected default object (e.g. an object ID).

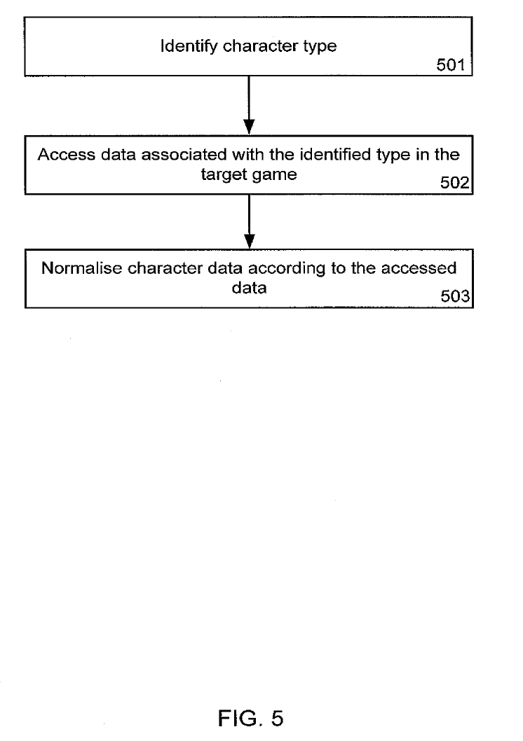

FIG. 5 shows an example method of translating one or more aspects of a character in which a standard set of parameters associated with the target game are used to define some/all of the parameters for the character being imported. In this method, a character type is identified (step 501) from the exported character data (as in step 401). Data associated with the identified type in the target game is then accessed (step 502) and this identified data is used to translate the character data (step 503). The data associated with the identified type may comprise a value of a parameter for the character (also referred to as a value associated with a character attribute) and this value may be used to translate the corresponding value in the exported character data (e.g. by changing the value from that in the exported character data to the value in the accessed data). In an example, the exported character data may contain a model in which the character is a humanoid and has a height of 10 (in arbitrary units). The character type of ‘humanoid’ is identified (in step 501) and data relating to type ‘humanoid’ in the target game is accessed (in step 502), which includes a standard humanoid height value of 5 (in the same or different units). Therefore, the character data is adjusted (in step 503) such that the new height of that character corresponds to the standard height parameter in the target game (a height value of 5). Consequently, the imported character will be the same size as other humanoids within the target game and not be too large, as would have been the case without such translation. Although the parameter may refer to a single attribute (e.g. size), other attributes may also be changed in a corresponding manner (e.g. weight, width etc may be scaled accordingly). Although the example of size is used, a similar process may be used to re-scale other attributes according to parameters specified in the target game (e.g. strength, weight, fitness etc) and one or more parameters may be adjusted in this process. Where a standard data set for a character type is specified which is applicable to multiple games (e.g. all the games from a particular games studio or collection of games), the data accessed (in step 502), whilst being applicable to the target game, may not be specific to that target game e.g. data associated with the identified type in the standard data set may be accessed. The standard data set may be stored locally (e.g. on a gaming device or other computer or may be stored in a central location such as on a gaming server).

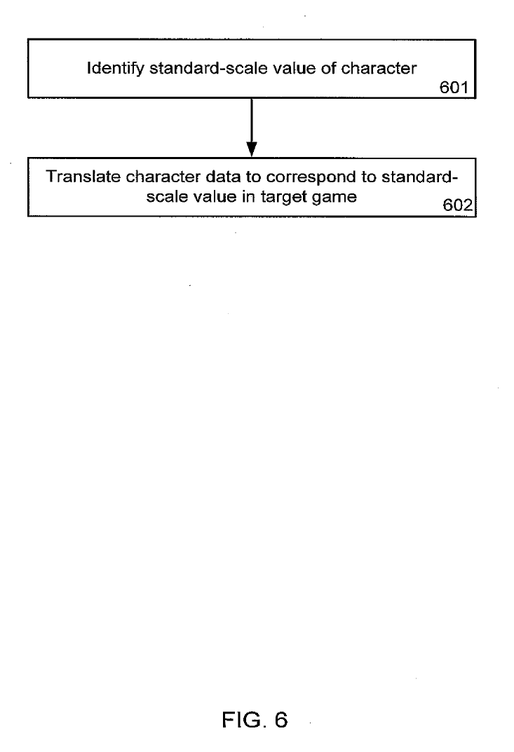

FIG. 6 shows another example method of translating one or more aspects of a character which has been exported from the source game and which is to be imported into the target game. According to this method, an aspect of the character (e.g. their height or weight) has a real-world or standard-scale size value associated with it, e.g. a character may be 1.8 m tall and weigh 90 kg. This standard-scale value for an aspect of a character is identified (step 601) and then the character data is translated to the appropriate scale for the target game (step 602). In an example, the exported character data may contain a model in which the character has a height of 10 in arbitrary units and a standard-scale value of 1.8 m (i.e. in the source game 1 unit=0.18 m). In the target game however, 1 unit may correspond to a standard-scale value of 0.36 m. This standard-scale value is identified (in step 601) and the character data is adjusted to correspond to a standard-scale value of 1.8 m in the target game (in step 602), i.e. a height of 5 units in the target game. Any standard or reference scale may be used which is referenced in both the source and the target games.

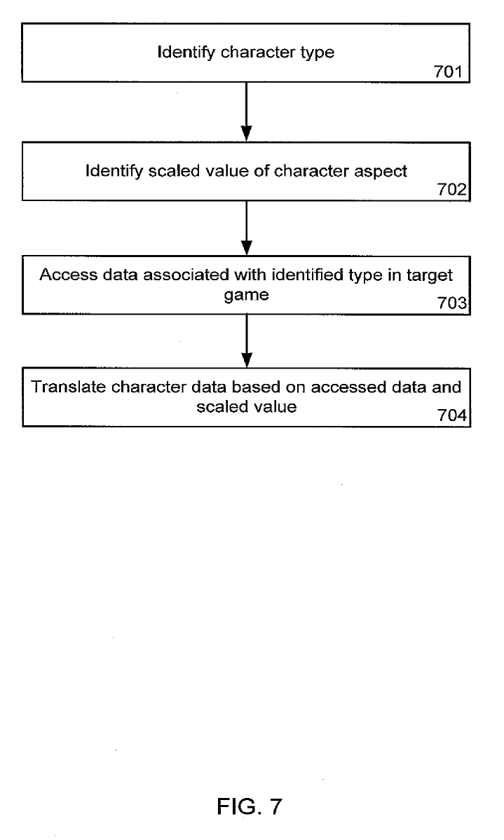

FIG. 7 shows a further example method of translating one or more aspects of a character which has been exported from the source game and which is to be imported into the target game. According to this method, characters are classified by type (as described above in relation to FIGS. 4 and 5) and aspects of a character (e.g. their height, weight, strength, fitness etc) have an associated scaled value (or ‘relative value’) to indicate where the aspect of a character falls within a range of values for that character type. In an example, the scaled value may be a fractional value between zero and one, with zero indicating that the value equals the lowest value within the range and one indicating that the value equals the highest value within the range. In other examples, the scaled (or relative) value may be expressed as a percentage or in any other form. As shown in FIG. 7, the character type is identified (step 701) along with the scaled value of a particular character aspect (step 702). Data associated with the identified type in the target game is accessed (step 703) and using this accessed data and the scaled value, the character data for the particular aspect is translated (step 704). This method (as with the other methods described) may be used to translate more than one aspect of the character data either by performing the method on multiple aspects at substantially the same time or by repeating the method steps.

In an example, the exported character data may contain a model in which the character is a humanoid, has a height of 10 in arbitrary units and has a scaled height value of 0.5, indicating that that the character's height lies half way between the tallest humanoid (which would have a scaled height value of 1.0) and the shortest humanoid (which would have a scaled height value of 0.0). The character type of ‘humanoid’ and the scaled value for height of 0.5 are identified (in steps 701 and 702) and data relating to type ‘humanoid’ in the target game is accessed (in step 703). This data may indicate that in the target game, humanoids have a height which ranges between 3 and 7 units. Therefore, the character data is translated (in step 704) such that the height is 5 units, which is the midpoint in the range for the target game.

The example of a character's height is used by way of example only and the methods could be used for other aspects of the character (e.g. weight, speed, strength, intelligence, fitness) and could be used for both characters which are living creatures (e.g. humanoids, animals etc) and objects such as machines, buildings etc. The methods are also applicable to objects which may be carried by a character and may need translation such that they fit within the game world of the target game. For example, if the method of FIG. 7 is applied to a weapon such as a gun which may be carried by the exported character, the gun may have a scaled impact value of 0.8 indicating that this is a relatively effective weapon. Where the source game is set in a fantasy future world, this may indicate that the gun is of a particular type. If this is then imported into a target game which is set in the past (e.g. in the 18^{th} century), this scaled impact value of 0.8 may correspond to a cannon or other gun which is relatively effective within the range of guns available in the target game world. The scaled value may be used to adjust the character data (as described above) or alternatively, in another example, it may be used in the selection of one of a default set of characters/objects for the target game (as described above in relation to FIG. 4) by selection of a default object with a similar scaled value (e.g. a weapon of a similar impact value). Similarly the methods described may be used when a character is transferred from a medieval game to a futuristic game (in which case the impact of weapons may need to be increased).

In the methods described, information relating to an aspect of the character being exported and imported are identified (steps 301, 401, 501, 701, 702 and 802). This information may be a character type or any other parameter. The character data may include a standard data packet, such as an XML file, which contains one or more parameters which relate to the character and may be used in the translation process. In addition to providing information which is required to align the character with a game world, the data packet may be used in other ways, for example, by the character model to define what the character looks like (e.g. the packet may contain parameters for numbers of legs, color of hair etc). A data packet may relate to a character, an object, a feature etc or a data packet may relate to a character and associated features, objects etc. The data for a character (‘character data’) may comprise one or more of such data packets. As described above, the data packet may contain parameters such as standard-scale values or scaled values for properties of a character/object. In addition, or instead, the data packet may contain information on the properties of the character/object. For example, a data packet for a weapon may indicate how the weapon may be used (e.g. by firing, by swinging it about and hitting things etc) and how the weapon may harm or damage things (e.g. impact, burning, cutting etc). In another example, a data packet for a vehicle may indicate how the vehicle can be used (e.g. on land, on water, in the air etc) or move (e.g. top speed). Examples of the data which may be included in a data packet are shown below.

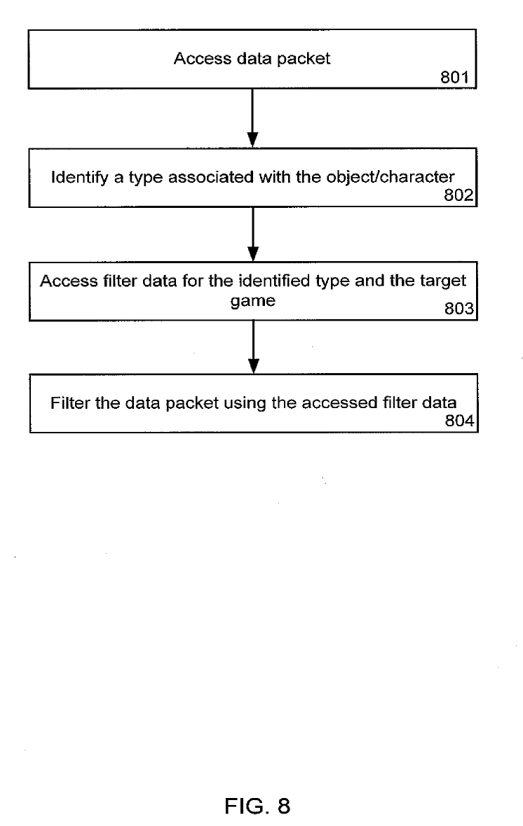

FIG. 8 shows an example method of translating one or more aspects of a character or object using a data packet associated with the character or object. The data packet is accessed (step 801) and a type associated with the character or object is identified (step 802). This type information may be stored within the data packet and where the data packet relates to more than one character/object (e.g. a character and one or more associated objects) the data packet may contain more than one element of type information. The data packet may contain information relating to sub-divisions of the type information e.g. class and sub-class information, as described below. Filter data is identified for the identified type and the target game (step 803) and this filter data is used to filter the data packet (step 804). The filter data, which may comprise a mask, ensures that parameters which are acceptable to the target world are read from the data packet and used to define the character/object whilst those parameters which are alien to the target world and/or fall outside defined boundaries are ignored such that the resultant character/object in the target world does not contain overpowering abilities or otherwise disrupt the illusion of the target game world. The parameters within the data packet (and/or within the character data) may be defined in terms of a common tagging system which may be understood by several games (e.g. a common set of parameters may be defined). These parameters may also be referred to as attributes.

In an example, the object may be a laser sword and the source game may be a fantasy game. The target game may, however, be a medieval game scenario in which laser swords do not exist and the powers of which would provide an unfair advantage in that game world (e.g. over a conventional sword or other period weapon). In this example, the data packet may include:

| Parameter | Value | Scaled Value |
|---|---|---|
| Type | Weapon | 0.5 |
| Class | Handheld weapon | |
| Sub-class | Sword | 1.0 |
| Operation | Swinging and hitting | |
| Impact | Burn/singe | 0.9 |

The scaled value of 0.5 for the value ‘weapon’ indicates that the effectiveness of this weapon is at the middle of the range of the weapons available in the source game, but the data packet also indicates that this laser sword is the most powerful of all swords in that game (scaled value of 1.0) and is very effective at burning/singing (scaled value of 0.9). This might compare to a data packet for a conventional sword:

| Parameter | Value | Scaled Value |
|---|---|---|
| Type | Weapon | 0.3 |
| Class | Handheld weapon | |
| Sub-class | Sword | 0.5 |
| Operation | Swinging and hitting | |
| Impact | Cut | 0.5 |

The type associated with the laser sword data packet may be identified as ‘weapon’ or alternatively, depending on the granularity used, the type may be identified as ‘handheld weapon’ or ‘sword’. Having identified a type, filter data for the identified type and the target game can be accessed and used. A first target game, game A, may not allow burning swords (i.e. swords which are capable of burning rather than cutting) and therefore the ‘impact’ data may be ignored and the laser sword may either not be permitted to be imported into game A or the data may be translated to be a conventional sword with a scaled value of 1.0 (i.e. the most powerful sword permitted within game A). A second target game, game B, may however allow burning swords within particular power limits, and therefore the data may be translated to be a burning sword with a power which is near the upper limit of the power, as defined by the scaled value of 0.9.

In another example, where the data packet is in the form of an XML file, the XML for a creature type exported from a first game (game A) may have attributes entitled “NumberOfLimbs”, “NumberOfMotionLimbs”, “NumberOfEyes”, “PrimaryMovementMethod”, “PrimaryAttackMethod” etc. The data packet for a humanoid character may then identify that it has four limbs in total with two of them for motion, two eyes, walking as “PrimaryMovementMethod” and punching as “PrimaryAttackMethod”. The data packet for a fish, exported from the same game, may detail two limbs (fins), none of which are used for motion (it uses its tail instead), two eyes, swimming as “PrimaryMovementMethod” and no attack method. However, whilst a second game (game B) may also use this set of attributes it might also have other attributes in its exported XML entitled “Intelligence”, “FoodType”, “Race”, “Religion”. When a character is exported from game A and imported into game B, the XML character data is searched for all the attribute types that game B recognizes and game B acts on those it finds appropriately. If alternatively a character from game B is exported and imported into game A then game A will only search (e.g. by name) for those original five attributes that it understands. As it has no knowledge about “Race”, “Religion” etc, game A will not search for them and therefore will not act on them. If the game into which a character is imported has no interest in a particular attribute (such as the “NumberOfEyes”), it does not search for that parameter in the XML it imports and then interprets. This technique is easily scalable.

In some examples, it may be desirable to have one or more abstract attributes held in the data packet (e.g. in the XML file) which give a greater scope for interpretation and integration. For example, the “NumberOfMotionLimbs” attribute could be dropped and both games could instead simply use a “NumberOfLimbs” value. This is more abstract, but may in some examples be used to transfer a character more appropriately. For example, an upright bipedal humanoid character could be exported from a first game set in the 21st Century and imported into a second game set 100,000 years ago. In this example the character may need to align with the characters in the second game which may be ancient men that walk around on all four limbs. Although changing the motion of the exported and imported character from walking on two legs to walking on all fours would be a fundamental change to the character's original attributes, but it would align that character with the world being entered. Such techniques provide a high level of flexibility and scalability.

In another example, the character data may contain information on several different types of weapons which are carried by the character in the source game (e.g. guns and knives). However, the target game might only recognize guns and bombs. Therefore the concept of knives and bombs may be only known to their respective game worlds but guns may be common and may therefore be meaningfully transferred as an active object where a character is transferred between games. In such a situation, XML may be used to transfer the data, as mentioned above, whether for guns, knives or bombs, and the translation process may only take from the XML data that data which is relevant to objects understood in the target game world. Therefore, in the example given above the source game may export XML detailing guns and knives carried by a character but the translation process may filter out the knives data (and therefore knives objects) and only allow the guns data from the XML data to be imported.

It will be appreciated that whilst the above examples describe the use of XML for the character data, this is just one possible mechanism which may be used and others may be alternatively used.

The filter data for a particular game (as accessed in step 803) may be fixed when the game is written or it may be possible to update this data (e.g. by providing a new mask) so as to allow additional character traits or object characteristics (such as ones which were not envisaged when the game was written) to be imported into the game In an example, the developers of game A (see example above) may provide an updated mask (e.g. by placing it on a server on which the game runs) which includes extra information (e.g. to allow the previously blocked burning capability of a sword through) and specifies limits on the power of the device such that it can be aligned to the game.

As described above in relation to FIG. 8, where characteristics are considered too alien for the target game, they may be ignored. In a corresponding manner, if the translation method (e.g. as shown in any of FIGS. 4-8) identifies that the whole character/object is too alien for the target game, e.g. because one or more aspects are outside defined boundaries, then the character/object may not be permitted to be imported into the target game. In another example, a character (or an object associated with a character) may not be imported where the character has a known attribute type (e.g. “VehicleType” or “TransportMedium”) but the attribute assigned to it is unknown. For example, where VehicleType=ship and the character is being imported into a game set on a dry arid world where ships don't exist, or where TransportMedium=space (where the character is a spaceship) and the character is being imported into a game set in Victorian England. In this way, the receiving game may simply discard characters having attribute parameters that it has not be pre-programmed to handle, possibly because they were too alien to be considered by the development team or were otherwise not envisaged by the development team.

A game may, in some examples, incorporate a procedural engine that can interpret new and foreign forms of characters e.g. by analyzing some or all of the data that comes with the character to see whether it can interpret it, rather than rejecting it based on an unknown attribute type or attribute. The procedural engine may, having analyzed the data, decide that the individual parts making up a character are too alien, or not understandable, or their collective purpose is not easily understood and then it may discard the character at that point. The procedural engine may also seek out further plug-ins (e.g. from a game server) to extend its capabilities to understand a character which is being imported prior to rejecting it on the basis that the data cannot be interpreted or the character is too alien to the target game.

An object which is blocked from importation in this way may be not displayable within the target game or alternatively, the graphical data for the object may still be imported into the game such that the object may be displayed but not used. Where an object is blocked and that object is carried by a character which is imported into the game, the data associated with the blocked object may be retained such that if the character is subsequently transferred from the target game into another game where that blocked object would be allowed, it can become an active object again.

The method of FIG. 8 may in an example be implemented using a standardized scripting language for the data packet, where the language has been specially created to allow the definition the features, protocols, data types & formats used by characters/objects. Any game engine incorporating an interpreter for this scripting language would be able to understand scripts passed to it and to process them appropriately (step 804). If new advances in any of the features or data types were made then they may be reflected in the scripts associated with them (thus making the scripts into assets alongside textures, models, skeletons, etc). The various assets for a character may be stored in a common format understood by the scripting language, and as they get imported into a game they may be automatically converted into valid optimized in-game assets that can be used more directly by that game engine, but could go through a different conversion process from the standard if imported into another different game engine.

As described above, where characters/objects are created by a user, the exported data may include data on how the character/object behaves (e.g. to define the full range of abilities of such a creation) and this may be included within the data packet using the available parameters (e.g. using a common tagging system) or in the form of a plug-in which can be imported into the target game. Depending on the complexity of the created character/object, the plug-in may be a large piece of code. In order that the target game can understand and utilize this common plug-in, standard asset types and object handling types may be used or a higher level scripted system or common scripting language may be used. The higher level scripted system or common scripting language may be designed to allow developers to define functionality of an object, or to define the procedural algorithm to analyze the construction of an object and calculate its functionality and limits. In this case a standard script driven engine may be employed within games so that they can accept scripts of this type to allow them to import these complex objects. Such an implementation, where the script engine itself can receive plug-ins, enables its functionality to be enhanced (e.g. after the release of a game) to accept newer scripting instructions or more advanced techniques within scripts and this may result in only requiring importation of smaller plug-ins as part of the character data. The plug-ins which upgrade a scripting engine may be placed on a server for download and/or may be distributed over a peer-to-peer network. They may be transferred to gaming devices in a similar manner to Windows (trade mark) updates.

Having translated aspects of the character, as described above, the character can be imported into the target game. Where the performance of a character or any associated object (e.g. carried by the character) has been changed as part of the translation process, the importation process may alert the gamer to that change (e.g. via a pop up stating “Your laser sword has been converted to a conventional sword for the purposes of this game”). In another example, the alert may be provided as part of the translation process or the alert may be provided when the gamer first uses the object in question within the target game or at random or pre-determined times after entry to the target game world.

Whilst the translation methods are described above independently from the export and import processes, it will be appreciated that the translation methods may be integrated with either the export or the import processes or could alternatively comprise a stand-alone process.

As described above, the term ‘character’ is used herein to refer to both living creatures (e.g. animals, humans, alien life forms etc) and objects, such as machines (e.g. vehicles and other craft etc) and buildings. The above methods are therefore applicable both to living creatures and objects.

Where the target game is a multiplayer game, the imported character data may need to be provided to other gaming devices which are participating in the game. This may be achieved as described in co-pending U.S. patent application Ser. No. 11/425,258, entitled ‘Transfer of Features Between Gaming Devices’, filed on 20 Jun. 2006, which is incorporated herein by reference.

Although the above methods refer to the importation of a character into a target game, the character may alternatively be imported into a target application which may not necessarily be a gaming application. For example, the character may be imported into a screensaver application, a presentation application, a graphics application (e.g. for still images or moving images) etc. The application may run on any suitable device including, but not limited to a gaming device, a mobile telephone, a PDA, and other computing devices.

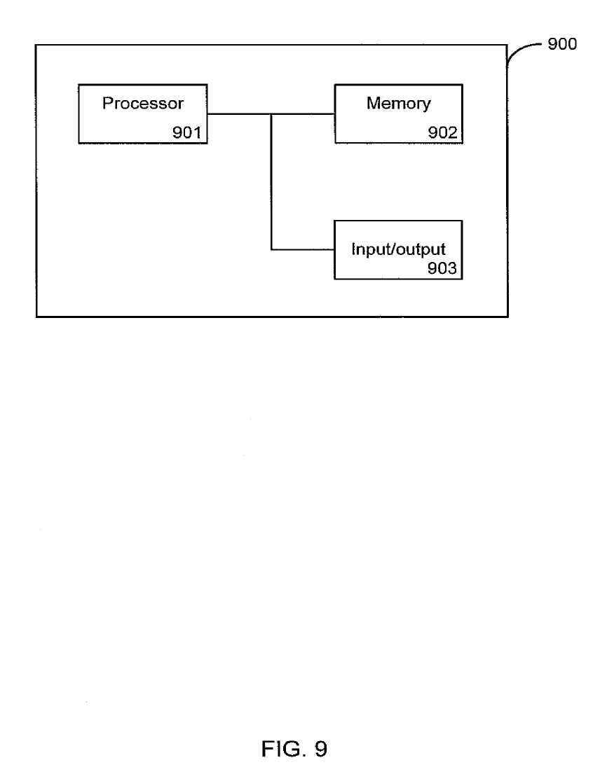

The above methods may be implemented on an apparatus 900 as shown in FIG. 9 which comprises a processor 901 and a memory 902 arranged to store executable instructions to cause the processor 901 to perform the required steps to implement one of the methods described herein. These instructions may be stored on removable media (e.g. a DVD or CD-ROM) or the memory 902 may be non-removable under normal operation of the apparatus. The apparatus may also comprise an input/output 903 for exporting and/or importing character data. As described above, the apparatus may perform one or more of the steps of exporting, translating and importing as shown in FIG. 2.

Although the present examples are described and illustrated herein as being implemented in a system as shown in FIG. 9, the system described is provided as an example and not a limitation. As those skilled in the art will appreciate, the present examples are suitable for application in a variety of different types of systems with processing capabilities.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person. It will be appreciated that references to “an item” or “a thing” refer to one or more of those objects or things.

The steps of the methods described herein may be carried out in any suitable order, or simultaneously where appropriate.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method comprising:
identifying a parameter from exported character data from a source game, said exported character data relating to a character in said source game;
identifying a target application; and
modifying said exported character data into amended character data suitable for use in said target application based on said parameter and said target application.

2. A method according to claim 1, wherein said target application is a game.

3. A method according to claim 1, wherein said parameter comprises a character type.

4. A method according to claim 3, wherein modifying said exported character data into amended character data suitable for use in said target application based on said parameter and said target application comprises:
accessing data associated with said character type and said target application; and
modifying said exported character data into said amended character data using said accessed data.

5. A method according to claim 4, wherein:
said accessed data comprises data relating to a plurality of standard characters associated with said target application; and
modifying said exported character data into said amended character data using said accessed data comprises:
selecting one of said plurality of standard characters based on said character type; and
modifying said exported character data into amended character data based on said selected one of said plurality of standard characters.

6. A method according to claim 4, wherein:
said exported character data comprises a value associated with a character attribute;
said accessed data comprises a target value of said character attribute; and
said amended character data comprises an amended value associated with said character attribute equal to said target value

7. A method according to claim 4, wherein:
said exported character data comprises a relative value associated with a character attribute;
said accessed data comprises a target range of values of said character attribute;
said amended character data comprises an amended value associated with said character attribute, and wherein said amended value is within said target range and based on said relative value.

8. A method according to claim 4, wherein said accessed data comprises filter data and wherein modifying said exported character data into amended character data using said accessed data comprises:
filtering said exported character data using said filter data to produce said amended character data.

9. A method according to claim 8, wherein said exported character data comprises a data packet, said data packet comprising a plurality of parameters associated with said character and a value for each of said plurality of parameters.

10. A method according to claim 9, wherein said amended character data comprises a second data packet, said second data packet comprising a sub-set of said plurality of parameters associated with said character and a value for each of said sub-set of said plurality of parameters.

11. A method according to claim 1, wherein said exported character data comprises a value associated with a character attribute, said value being defined with respect to a scale, and wherein modifying said exported character data into amended character data suitable for use in said target application based on said parameter and said target application comprises:
accessing conversion data associated with said target application, said conversion data being defined with respect to said scale; and
modifying said exported character data into amended character data based on said value and said conversion data.

12. A method according to claim 11, wherein said scale comprises a scale defined in a standard unit of measurement.

13. A method according to claim 1, further comprising, prior to identifying said parameter:
exporting said exported character data from said source game.

14. A method according to claim 1, further comprising:
importing said amended character data into said target application.

15. One or more device-readable media with device-executable instructions for performing steps comprising:
identifying a parameter from exported character data from a source game, said exported character data relating to a character in said source game;
identifying a target application; and
modifying said exported character data into amended character data suitable for use in said target application based on said parameter and said target application.

16. An apparatus comprising:
a processor; and
a memory arranged to store executable instructions arranged to cause the processor to:
identify a parameter from exported character data from a source game, said exported character data relating to a character in said source game;
identify a target application; and
modify said exported character data into amended character data suitable for use in said target application based on said parameter and said target application
